(19) United States
(12) Patent Application Publication
(10) Pub. No.: US 2010/0039483 A1
(43) Pub. Date: Feb. 18, 2010

(54) Impregnation Fluid for Capturing Member, Capturing Member for Ink-Jet Printer, and Ink-Jet Printer

(76) Inventor: Hidehiko Komatsu, Nagano-ken (JP)

Correspondence Address: LADAS & PARRY LLP, 26 WEST 61ST STREET, NEW YORK, NY, 10023, US

(21) Appl. No.: 11/885,616

(22) PCT Filed: Mar. 8, 2006
(86) PCT No.: PCT/JP2006/304499

§ 371 Date: Sep. 29, 2009

(30) Foreign Application Priority Data
Mar. 8, 2005 (JP) 2005-063481
Mar. 8, 2005 (JP) 2005-063488

(51) Int. Cl. B41J 2/17; C08L 39/00; C08L 33/00; C08K 5/17; C08K 5/47; C08K 5/053

(52) U.S. Cl. 347/84; 524/555; 524/556; 524/247; 524/83; 524/377; 524/388

(57) ABSTRACT

The invention provides an impregnation liquid containing at least one resin selected from the group consisting of a hardly water-soluble resin and a water-soluble resin to be impregnated into a capturing member for directly capturing ink droplets ejected to areas other than a recording medium among the ink droplets ejected from the printer head for ink-jet recording; a capturing member for ink-jet printer containing the impregnation liquid; and an ink-jet printer equipped with the capturing member.

### TECHNICAL FIELD

The present invention relates to an impregnation liquid for capturing member, a capturing member for ink-jet printer, and ink-jet printer. According to the invention, for example, in rimless printing by an ink-jet recording method, the state of a capturing member for capturing ink droplets ejected to the areas other than a recording medium can be maintained in a good state for a long period of time.

### BACKGROUND ART

Also in an ink-jet recording system, rimless printing similar to that for a silver salt photography is performed. In rimless printing, it is necessary not to leave a nonimage area (a blank space) at the rim edge part of a recording medium at all and make the entire surface an image area. A proper image can be formed even to the rim edge part of a recording medium by ejecting ink droplets continuously from printer heads, from the surface of the recording medium to the outside of the rim edge part. The principle of the rimless printing conventionally used will be explained below with reference to the accompanying drawings.

In the first place, the principle of rimless printing is schematically shown in FIGS. 1 and 2. FIG. 1 is an enlarged perspective view of main parts, schematically showing the process of rimless printing according to ink-jet recording method; FIG. 1 (A) shows the state of printing onto the front rim part of the recording medium; FIG. 1 (B) shows the state of printing onto the side rim part of the recording medium; and FIG. 1 (C) shows the state of printing onto the rear rim part of the recording medium. FIG. 2 is a schematic side view of main parts of the state of FIG. 1 (A).

As shown in FIGS. 1 and 2, the ink-jet recording apparatus 10 has a recording head 13 mounted on a carriage 14 that moves reciprocally along a guide shaft 12 extending in the main scanning direction (i.e., the width direction of the recording paper 11; the direction of arrow B in FIG. 1), and a platen (not shown) arranged oppositely below recording head 13. Recording paper 11 is conveyed between the recording head 13 and the platen by paper feeding means (not shown) in the sub-scanning direction (the direction of arrow A in FIGS. 1 and 2).

As shown in FIGS. 1 (A) and 2, when the front rim part 11a of the recording paper 11 is conveyed to below the recording head 13, printing to the front rim part 11a is initiated. That is, printing is started when the recording head 13 ejects ink droplets 19 toward the recording paper 11 while reciprocally moving in the main scanning direction (the direction of arrow B) along the guide shaft 12. At this time, for performing printing without leaving blank spaces on the front rim part 11a of the recording paper 11, ink droplets 19 are also ejected on the outside of the front rim part 11a of the recording paper 11. The ink droplets 19 ejected on the outside of the front rim part 11a of the recording paper 11 are directly adhered to the capturing member 30 provided on the platen and penetrate into the inside of the capturing member 30 to form an ink liquid capturing area 31.

When printing to the front rim part 11a of the recording paper 11 is finished, the recording paper 11 is conveyed in the sub-scanning direction (the direction of arrow A), and the central part of the recording paper 11 is printed. In the printing to the central part, for the purpose of performing printing without leaving blank spaces at the side rim parts 11b on both sides of the recording paper 11, as shown in FIG. 1 (B), ink droplets 19 are also ejected on the outside of the side rim part 11b of the recording paper 11. The ink droplets 19 thus ejected on the outsides are directly adhered to the ink liquid capturing member 30 provided on the platen and captured. Further, when printing to the central part of the recording paper 11 is finished, the recording paper 11 is conveyed in the sub-scanning direction (the direction of arrow A), and the rear rim part 11c of the recording paper 11 is printed. In the printing to the rear rim part 11c, for the purpose of performing printing without leaving blank spaces on the rear rim part 11c of the recording paper 11, as shown in FIG. 1 (C), ink droplets 19 are also ejected on the outside of the rear rim part 11c of the recording paper 11. The ink droplets 19 are directly adhered to the ink liquid capturing member 30 provided on the platen and captured.

As shown in FIGS. 1 and 2, in performing the rimless printing, ink droplets 19 are also ejected on the outsides of the recording paper 11. Accordingly, it is necessary to provide a capturing member on a platen to prevent the back surface of the recording paper 11 from being contaminated with the ejected ink droplets 19. A representative ink-jet recording apparatus having provided with such a capturing member at a platen is shown in FIGS. 3 to 5.

FIG. 3 is a perspective view of a representative ink-jet recording apparatus 10A, and a case cover 1 is opened and its printing mechanism part is particularly shown. In the mechanism part, arranged are a carriage 4 mounting ink cartridges 2 and 3 and a recording head 4A, and a platen 5 at the position opposing to the moving course thereof. Further, at the locations sandwiching the platen 5, a first paper pressing roller 6 is arranged on the upstream side in the discharging direction of recording paper, and a second paper pressing roller 7 is arranged on the downstream side. FIG. 4 is a partial plan view of the printing mechanism part of ink-jet recording apparatus 10 shown in FIG. 3. FIG. 5 is a partial cross sectional view of the printing mechanism part of ink-jet recording apparatus 10 shown in FIG. 3.

Especially as shown in FIGS. 4 and 5, platen openings 5a, 5b and 5c are provided at a part of the platen 5, and the capturing member 20 is arranged below the platen 5. The platen opening 5a is a window for directly capturing ink droplets without adhering ink droplets to the surface of the platen 5 or without generating ink mist upon printing onto the front rim part of the recording paper P, and the platen openings 5b and 5c are windows to be used upon printing onto the side rim part and rear rim part of the recording paper, respectively. That is, of the ink droplets ejected from the recording head 4A, all the ink droplets ejected to the outside of the recording paper P pass through the platen openings 5a, 5b or 5c, and directly captured by the capturing member 20. Incidentally, the recording paper P is conveyed with the back surface thereof being in contact with the surface of platen S. It is necessary to place the capturing member 20 at such a height that the back surface of recording paper P at the time of conveyance does not contact the top surface of the capturing member 20.

As shown in FIG. 5, the capturing member 20 is supported by a supporting member 8, and the supporting member 8 is provided with a supporting member opening 8a. A waste ink tank 9 is provided below the support member, and the ink liquid temporarily captured by the capturing member 20 is gradually introduced into the waste ink tank 9 from the supporting member opening 8a and absorbed and held by an absorption holding member generally provided in the waste ink tank 9.

In the specification of the invention, “below” or “above” regarding the printer means below or above in connection with the direction of gravity in the state where printing is carried out with the printer.

In recent years, pigment inks are adopted mainly for the purpose of improvement of preservability of printed matters. Since the capturing members as described above are generally formed of porous materials (e.g., urethane foam), especially in the case of pigment inks, there is the tendency that only solvent components penetrate into the inside of the capturing member, and pigment particles remain on the surface of the porous capturing materials and accumulate. When the accumulation of the pigment particles gradually grows on the surface of the porous capturing member and protrudes above the platen opening, the pigment particles are adhered to the back side of the recording paper, further the pigment particles are transferred from the back side of the recording paper to the surface of platen, which may leads to contamination of the back side of another recording paper.

The techniques for preventing the accumulation of pigment particles are already proposed. For example, a technique of impregnating the capturing member with an organic solvent is known (patent document 1). A technique of the impregnation with an organic solvent selected according to the kind of color of pigment ink is also known (patent document 2). Further, a technique of designing the capturing member to have a multilayer structure of two or more layers including a receptive layer and a diffusive layer is known (patent document 3). Still further, a technique of accelerating penetration by making a through hole on the capturing member is known (patent document 4).

Patent Document 1: JP-A-2003-191545

Patent Document 2: JP-A-2004-174978

Patent Document 3: JP-A-2003-39754

Patent Document 4: JP-A-2004-1485

### DISCLOSURE OF THE INVENTION

### Problems to be Solved by the Invention

In the course of the intensive study of techniques of preventing accumulation of pigment particles on the surface of a porous capturing member, the present inventor found that surface accumulation of pigment particles can be extremely effectively prevented by different means from conventionally proposed methods, that is, by the impregnation of a capturing member in advance with at least one resin selected from the group consisting of a hardly water soluble resin and a water-soluble resin.

The above-described means that the inventor found is superior in the effect, as compared with the technique disclosed in patent document 1 of impregnating the capturing member with an organic solvent, as shown in the below-described Examples, and can effectively prevent the accumulation of pigment particles on the surface of a porous capturing member.

The present invention is based on the finding.

### Means for Solving the Problems

The inventor found, as a result of intensive study of the foregoing problems, that the above objects of the invention can be achieved by means of the following impregnation liquid, capturing member, and ink-jet printer, thereby leading to the completion of the invention. That is, the objects of the invention have been achieved by the following impregnation liquid, capturing member, and ink-jet printer.

(1) An impregnation liquid that is to be impregnated in a capturing member for directly capturing ink droplets ejected to an area other than a recording medium among ink droplet ejected from a printer head for ink-jet recording, which contains at least one resin selected from the group consisting of a hardly water-soluble resin and a water-soluble resin.

(2) The impregnation liquid as described in the above item (1), wherein the hardly water-soluble resin contains a hardly water-soluble resin obtained by polymerization of at least one monomer selected from the group consisting of acrylic monomer, methacrylic monomer, vinyl monomer, maleic acid, maleic anhydride, styrene, itaconic acid, N-vinylpyrrolidone, acrylamide, methacrylamide, and derivatives thereof.

(3) The impregnation liquid as described in the above item (2), wherein the methacrylic monomer comprises at least one monomer selected from the group consisting of methyl methacrylate (MMA), ethyl methacrylate (EMA), propyl methacrylate, n-butyl methacrylate (MBA or NBMA), hexyl methacrylate, 2-ethylhexyl methacrylate (EHMA), octyl methacrylate, lauryl methacrylate (LMA), stearyl methacrylate, phenyl methacrylate, hydroxyethyl methacrylate (HEMA), hydroxypropyl methacrylate, ethoxytriethylene glycol methacrylate (ETEGMA), 2 ethoxyethyl methacrylate, methacrylonitrile, 2-trimethylsiloxyethyl methacrylate, glycidyl methacrylate (GMA), p-tolyl methacrylate, methacrylic acid (MAA), dimethylaminoethyl methacrylate (DMAEMA), diethylaminoethyl methacrylate, t-butylaminoethyl methacrylate, and sorbyl methacrylate.

(4) The impregnation liquid as described in the above item (2), wherein the acrylic monomer comprises at least one monomer selected from the group consisting of methyl acrylate, ethyl acrylate, propyl acrylate, butyl acrylate, hexyl acrylate, 2-ethylhexyl acrylate, octyl acrylate, lauryl acrylate, stearyl acrylate, phenyl acrylate, hydroxyethyl acrylate, hydroxypropyl acrylate, acrylonitrile, 2-trimethylsiloxy-ethyl acrylate, glycidyl acrylate, p-tolyl acrylate, sorbyl acrylate, acrylic acid, dimethylaminoethyl acrylate, and diethylaminoethyl acrylate.

(5) The impregnation liquid as described in the above item (1), wherein the water-soluble resin is a compound having a hydrophilic structural part and a hydrophobic structural part.

(6) The impregnation liquid as described in any of the above items (1) to (5), which further contains a water-soluble solvent.

(7) The impregnation liquid as described in the above item (6), wherein the water-soluble solvent comprises at least one member having a vapor pressure at 20° C. of 0.01 mmHg or less.

(8) A capturing member for an ink-jet printer for directly capturing ink droplets ejected to an area other than a recording medium among ink droplets ejected from a printer head for ink-jet recording, which is impregnated with and contains at least one resin selected from the group consisting of a hardly water-soluble resin and a water-soluble resin.

(9) The capturing member as described in the above item (8), which carries the at least one resin selected from the group consisting of a hardly water-soluble resin and a water-soluble resin in a wet state or in a dry state.

(10) The capturing member as described in the above item (8) or (9), which has a multilayer structure.

(11) An ink-jet printer equipped with the capturing member as described in any of the above items (8) to (10).

(12) The ink-jet printer as described in the above item (11), wherein a colorant of ink to be used is a pigment.

### ADVANTAGES OF THE INVENTION

According to the invention, as shown in the below-described Examples, accumulation of pigment particles on the surface of a capturing member used in rimless printing by an ink-jet recording system can be effectively prevented or restrained.

In an aqueous pigment ink composition generally used in ink-jet recording system, pigment particles are thoroughly and stably dispersed. The details of mechanism that pigment particles nevertheless accumulate on the surface of a capturing member are not clarified up to the present. Accordingly, the mechanism of capable of effectively preventing or restraining the accumulation of pigment particles by impregnating a capturing member in advance with at least a resin selected from the group consisting of a hardly water-soluble resin and a water soluble resin is also not clear.

However, as shown in the below-described Examples, by the impregnation of a capturing member in advance with at least a resin selected from the group consisting of a hardly water soluble resin and a water-soluble resin, it is supposed that the destruction of dispersion system in an ink composition attached to the capturing member is prevented or restrained, so that the function as capturing member can be maintained in a good state for a long period of time, as a result the long duration of life of the capturing member can be realized.

### BRIEF DESCRIPTION OF THE DRAWINGS

FIG. 1 (A) is an enlarged perspective view of main parts schematically showing the process of rimless printing according to ink-jet recording method.

FIG. 1 (B) is a perspective view showing the state of printing onto the side rim part of the recording medium.

FIG. 1 (C) is a perspective view showing the state of printing onto the rear rim part of the recording medium.

FIG. 2 is a schematic side view of main parts of the state of FIG. 1 (A).

FIG. 3 is a perspective view showing a representative ink-jet recording apparatus.

FIG. 4 is a partial plan view showing the printing mechanism part of the ink-jet printer shown in FIG. 3.

FIG. 5 is another partial cross-sectional view showing the printing mechanism part of the ink-jet printer shown in FIG. 3.

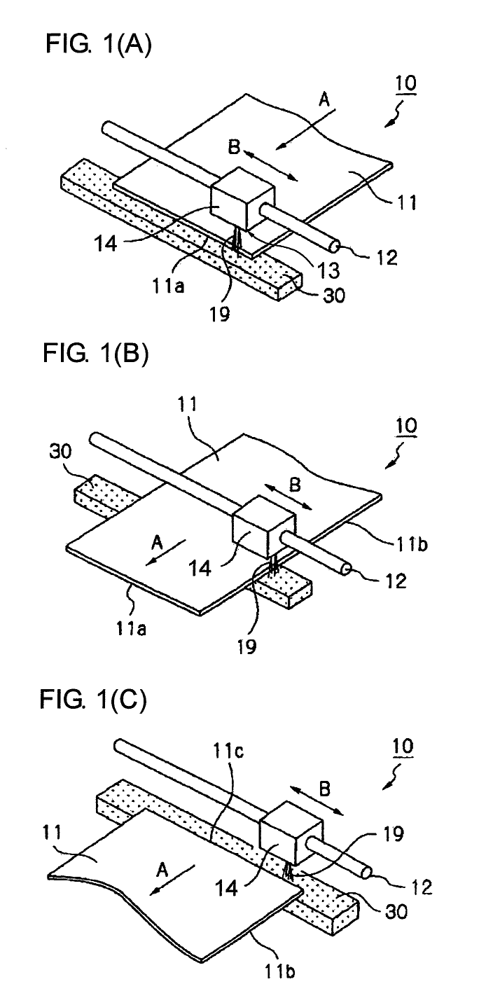

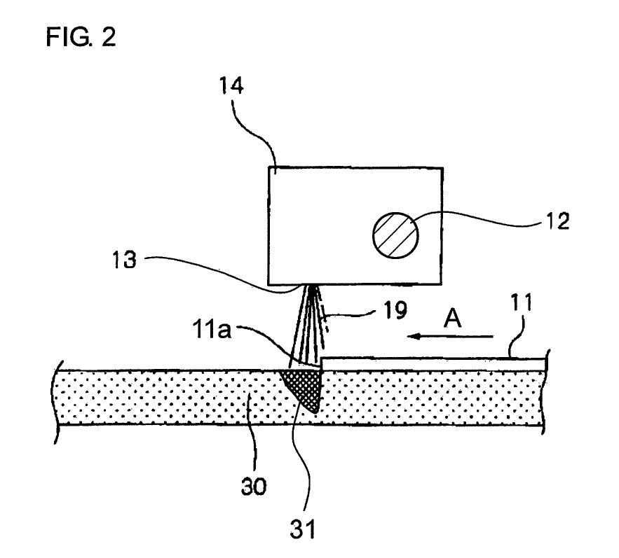

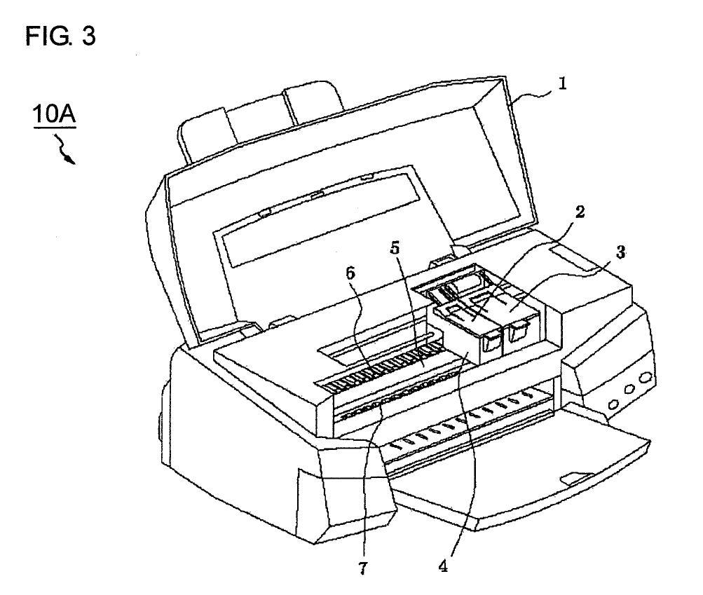

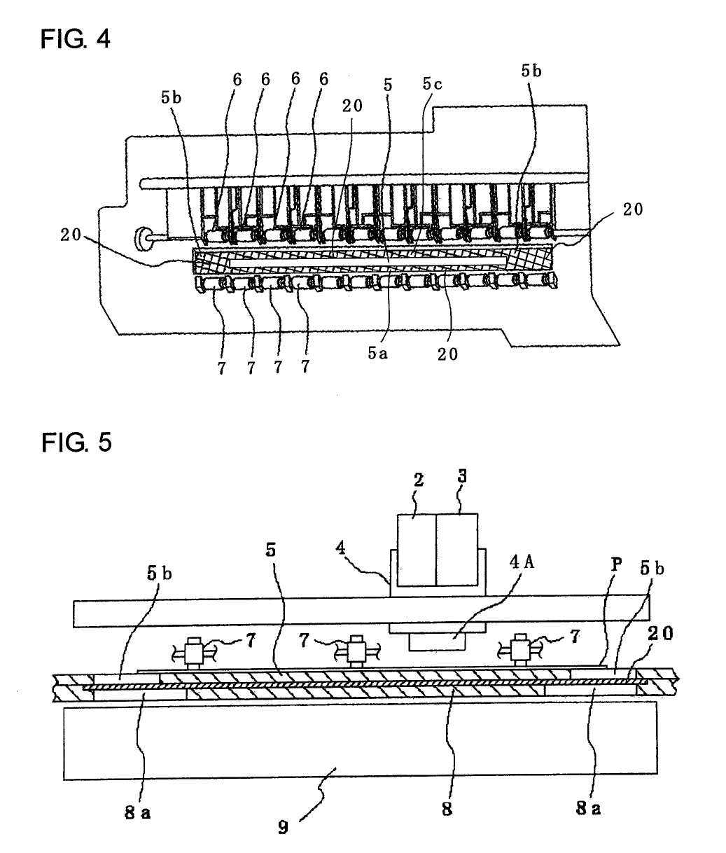

### DESCRIPTION OF REFERENCE NUMERALS AND SIGNS

1: Case cover
2, 3: Ink cartridge
4: Carriage
4A: Recording head
5: Platen
5a, 5b, 5c: Platen opening
6: First paper pressing roller
7: Second paper pressing roller
8: Supporting member
8a: Supporting member opening
9: Waste ink tank
10, 10A: Ink-jet recording apparatus
11: Recording paper
11a: Front rim part of recording paper
11b: Side rim part of recording paper
11c: Rear rim part of recording paper
12: Guide shaft
13: Recording head
14: Carriage
19: Ink droplets
20: Capturing member
30: Capturing member
31: Ink liquid capturing area

### BEST MODE FOR CARRYING OUT THE INVENTION

The impregnation liquid of the invention contains at least one resin selected from the group consisting of a hardly water-soluble resin and a water-soluble resin.

The hardly water-soluble resin for use in the invention can be contained in the impregnation liquid of the invention in the form of an aqueous emulsion polymer.

The hardly water-soluble resin for use in the invention can be prepared from the monomer selected from the group consisting of acrylic monomer; methacrylic monomer; vinyl monomer (e.g., vinyl acetate or vinyl chloride); maleic acid; maleic anhydride; styrene; itaconic acid; N-vinylpyrrolidone; acrylamide; methacrylamide; and the derivatives thereof.

The representative acrylic or methacrylic monomers include methyl methacrylate (MMA), ethyl methacrylate (EMA), propyl methacrylate, n-butyl methacrylate (MBA or NBMA), hexyl methacrylate, 2-ethylhexyl methacrylate (EHMA), octyl methacrylate, lauryl methacrylate (LMA), stearyl methacrylate, phenyl methacrylate, hydroxyethyl methacrylate (HEMA), hydroxypropyl methacrylate, ethoxytriethylene glycol methacrylate (ETEGMA), 2-ethoxyethyl methacrylate, methacrylonitrile, 2-trimethylsiloxyethyl methacrylate, glycidyl methacrylate (GMA), zonyl fluoromethacrylate, p-tolyl methacrylate, sorbyl methacrylate, methyl acrylate, ethyl acrylate, propyl acrylate, butyl acrylate, hexyl acrylate, 2-ethylhexyl acrylate, octyl acrylate, lauryl acrylate, stearyl acrylate, phenyl acrylate, hydroxyethyl acrylate, hydroxypropyl acrylate, acrylonitrile, 2-trimethylsiloxyethyl acrylate, glycidyl acrylate, p-tolyl acrylate, sorbyl acrylate, methacrylic acid (MAA), acrylic acid, dimethylaminoethyl methacrylate (DMAEMA), diethylaminoethyl methacrylate, t-butylaminoethyl methacrylate, dimethylaminoethyl acrylate, diethylaminoethyl acrylate, dimethylaminopropylmethacrylamide, methacrylamide, acrylamide, and dimethylacrylamide. Preferred acrylic or methacrylic monomers are hardly water-soluble resins prepared from methyl methacrylate, butyl methacrylate, 2-ethylhexyl methacrylate, the combination of butyl methacrylate and methyl methacrylate, methacrylic acid, or dimethylaminoethyl methacrylate.

The hardly water-soluble resins for use in the invention may contain a small amount of crosslinkable monomers such as ethylene glycol dimethacrylate or ethylene glycol triacrylate. Further, the hardly water-soluble resins can also vary the solubility to a certain degree by further containing a hydrophilic monomer represented by the following formula:

CH₂═C(X)(Y′)

(in the formula, X represents H or CH₃; Y′ represents C(O)OH, C(O)NR²R³, C(O)OR⁴NR²R³, C(O)OR⁵, or the salt thereof; R² and R³ each represents H, an alkyl group having from 1 to 9 carbon atoms, an aryl group, or an alkylaryl group; R⁴ represents an alkylene group having from 1 to 5 carbon atoms; and R⁵ represents an alkylene group having from 1 to 20 carbon atoms, which contains a hydroxyl group or an ether group according to circumstances). However, hydrophilic monomers should not be present in the hardly water-soluble resins in the amount sufficient to make the hardly water-soluble resins or the salts thereof completely water-soluble.

The hardly water-soluble resins for use in the invention can also be stabilized with a monomeric or polymeric stabilizer. The useful monomeric stabilizers include N,N,N-trimethyl-1-dodecaninium chloride, dimethyl-dodecaninium chloride, polyethylene glycol derivatives of alkylphenol, sodium lauryl sulfate, and ammonium N-alkyltrimethyl chloride. As a commercially available monomeric stabilizer, e.g., ammonium dodecyltrimethyl chloride (Arquad (registered trademark), manufactured by Akzo Chemicals Inc.) can be exemplified. The useful polymeric stabilizers include structural polymers selected from the group consisting of block polymers (such as diblock and triblock polymers) and graft polymers. As the useful diblock polymers, the compounds disclosed, e.g., in U.S. Pat. No. 5,085,698 can be used, and as the useful triblock polymers, the compounds disclosed, e.g., in U.S. Pat. No. 5,519,085 can be used. As the useful graft polymers, the compounds disclosed, e.g., in U.S. Pat. No. 5,231,131 can be used.

The water-soluble resin for use in the invention is a compound having a hydrophilic structural part and a hydrophobic structural part, and specifically addition polymers and condensation polymers can be exemplified. As the addition polymers, e.g., addition polymers of monomers having an α,β-ethylenic unsaturated group can be exemplified. As the addition polymers, e.g., polymers obtained by copolymerizing arbitrary combination of monomers having an α,β-ethylenic unsaturated group having a hydrophilic group and monomers having an α,β-ethylenic unsaturated group having a hydrophobic group can be used. Homopolymers of monomers having an α,β-ethylenic unsaturated group having a hydrophilic group can also be used.

As the monomers having an α,β-ethylenic unsaturated group having a hydrophilic group, for example, monomers having a carboxyl group, a sulfonic acid group, a hydroxyl group, or a phosphoric acid group, e.g., acrylic acid, methacrylic acid, crotonic acid, itaconic acid, itaconic monoester, maleic acid, maleic monoester, fumaric acid, fumaric monoester, vinyl-sulfonic acid, styrenesulfonic acid, sulfonated vinyl-naphthalene, vinyl alcohol, acrylamide, methacryloxyethyl phosphate, bis-methacryloxyethyl phosphate, methacryloxy-ethylphenyl acid phosphate, ethylene glycol dimethacrylate, or diethylene glycol dimethacrylate can be used.

On the other hand, as the monomers having an α,β-ethylenic unsaturated group having a hydrophobic group, e.g., styrene derivative such as styrene, α-methylstyrene, vinyltoluene, etc., vinylcyclohexane, vinylnaphthalene, vinylnaphthalene derivative, alkyl acrylic ester, phenyl acrylic ester, alkyl methacrylic ester, phenyl methacrylic ester, cycloalkyl methacrylic ester, alkyl crotonic ester, dialkyl itaconic ester, and dialkyl maleic ester can be used.

The copolymers obtained by copolymerizing the monomers having a hydrophilic group and a hydrophobic group may have any structure of random, block and graft copolymers. As preferred examples of the copolymers, styrene-styrenesulfonic acid copolymer, styrene-maleic acid copolymer, styrene-methacrylic acid copolymer, styrene-acrylic acid copolymer, vinylnaphthalene-maleic acid copolymer, vinylnaphthalene-methacrylic acid copolymer, vinylnaphthalene-acrylic acid copolymer, alkyl acrylic ester-acrylic acid copolymer, alkyl methacrylic ester-methacrylic acid, styrene-alkyl methacrylic ester-methacrylic acid copolymer, styrene-alkyl acrylic ester-acrylic acid copolymer, styrene-phenyl methacrylic ester-methacrylic acid copolymer, styrene-cyclohexyl methacrylic ester-methacrylic acid copolymer, etc., can be exemplified.

These copolymers may be appropriately copolymerized with monomers having a polyoxyethylene group or a hydroxyl group. It is also possible for these copolymers to be copolymerized with monomers having a cationic functional group, e.g., N,N-dimethylaminoethyl methacrylate, N,N-dimethylaminoethyl acrylate, N,N-dimethylaminomethacrylamide, N,N-dimethyl-aminoacrylamide, N-vinylpyrrole, N-vinylpyridine, N-vinylpyrrolidone, or N-vinylimidazole.

As the condensation polymers, known polyester polymers can be exemplified. As the polyester polymers, e.g., carboxyl group-containing polyester resins obtained by the reaction of polyvalent carboxylic acids and polyvalent alcohols under the condition of excessive carboxyl groups can be exemplified.

Specifically, as the polyvalent carboxylic acids, for example, aromatic dicarboxylic acids such as terephthalic acid, isophthalic acid, phthalic acid, 1,5-naphthalenedicarboxylic acid, 2,6-naphthalenedicarboxylic acid, diphenic acid, etc., aliphatic dicarboxylic acids such as succinic acid, adipic acid, azelaic acid, sebacic acid, dodecanedicarboxylic acid, etc., and unsaturated aliphatic or alicyclic dicarboxylic acids such as fumaric acid, maleic acid, itaconic acid, hexahydrophthalic acid, tetrahydrophthalic acid, etc., can be exemplified.

On the other hand, as the polyvalent alcohols, aliphatic diols such as ethylene glycol, propylene glycol, butylene glycol, polyethylene glycol, etc., trivalent or more aliphatic polyvalent alcohols such as trimethylolethane, glycerol, pentaerythritol, etc., alicyclic diols such as 1,4-cyclo-hexanediol, 1,4-cyclohexanedimethanol, spiro-glycerol, hydrogenated bisphenol A, tricyclodecane, tricyclodecane-dimethanol, etc., and aromatic diols such as para-xylene glycol, meta-xylene glycol, ortho-xylene glycol, 1,4-phenylene glycol, etc., can be exemplified.

Of the above components, dicarboxylic acids and diols are reacted in excessive hydroxyl groups in the first place, and then molecular terminals are reacted with trivalent or more polyvalent carboxylic acid such as trimellitic acid, trimesic acid, pyromellitic acid or the like, thus polyester resins having an appropriate acid value can be obtained.

The polyester polymers can also be phosphoric acid group-containing polyester resins. The phosphoric acid group-containing polyester resins can be obtained by using at least one of phosphoric acid, pyrophosphoric acid, polyphosphoric acid, and phosphorous acid in combination in the course of the reaction of the polyvalent alcohol compounds and polyvalent carboxylic acid compounds.

The polyester polymers can also be sulfone group-containing polyester resins. As the sulfone group-containing polyester resins, sulfone group-containing polyester resins obtained by using sulfone group-containing dicarboxylic acid, e.g., sulfoterephthalic acid, 5-sulfoisophthalic acid, 4-sulfophthalic acid, 4-sulfonaphthalene-2,7-dicarboxylic acid, or 5-(4-sulfophenoxy)isophthalic acid, or the metallic salt or ammonium salt thereof, with polyvalent alcohols can be exemplified.

The polyester polymers can also be polyurethane resins having an acid radical. The polyurethane resins having the acid radical are polyurethane resins obtained by reacting an organic diisocyanate compound and a polymer diol compound to synthesize a urethane prepolymer, and then reacting with a chain extender and a reaction terminator. As the polyurethane resins, carboxyl group-containing polyurethane resins utilizing a compound having a carboxyl group as the polymer diol compound, chain extender, etc., and sulfone group-containing polyurethane resins utilizing a compound having a sulfone group as the polymer diol compound can be exemplified.

As organic diisocyanate compounds of polyurethane resins for use as the water-soluble resins for impregnation liquid in the invention, isophorone diisocyanate and tetramethyl-xylylene diisocyanate are useful.

As the carboxyl group-containing polymer diol compounds, ethylene oxide adducts of dimethylolpropionic acid, reaction products of polyethylene glycol and pyromellitic anhydride, etc., and as the carboxyl group-containing chain extenders, carboxyl group-containing diol compounds, e.g., dimethylol-propionic acid, are useful.

Further, sulfone group-containing polyurethane resins can be obtained by using sulfone group-containing polyester diol obtained by the reaction of the sulfone group-containing dicarboxylic acid compound and a diol compound as the polymer diol component.

As the water-soluble resins, polystyrenesulfonic acid, polyacrylic acid, polymethacrylic acid, polyvinylsulfonic acid, polyalginic acid, polyoxyethylene-polyoxypropylene-polyoxyethylene block copolymer, formalin condensation product of naphthalenesulfonic acid, polyvinyl pyrrolidone, polyethyleneimine, polyamines, polyamides, polyvinyl imidazoline, aminoalkyl acrylate-acrylamide copolymer, chitosan, polyoxyethylene alkyl ether, polyoxyethylene alkyl phenyl ether, polyoxyethylene fatty acid amide, polyvinyl alcohol, polyacrylamide, cellulose derivatives such as carboxymethyl cellulose, carboxyethyl cellulose, etc., polysaccharide and derivatives thereof can also be effectively used in the invention.

The hydrophilic groups of the water-soluble resins are preferably carboxylic acid groups or carboxylic acid salt groups, although not particularly limited thereto. Of these water-soluble resins, copolymers in which hydrophilic groups are acidic groups are preferably used in the form of the salt with a basic substance for the purpose of increasing solubility in water. The examples of the basic substances forming a salt with these polymers include alkali metals, e.g., sodium, potassium, lithium, etc., aliphatic amines, e.g., monomethylamine, dimethylamine, triethylamine, etc., alcohol amines, e.g., monomethanolamine, monoethanolamine, diethanolamine, triethanolamine, diisopropanolamine, etc., and ammonia, etc. Of these compounds, basic compounds of alkali metals such as sodium, potassium, lithium, etc., can be preferably used. The reason for this is that alkali metals are strong electrolytes and have the effect of accelerating dissociation of hydrophilic groups.

It is more preferred that the water-soluble resins are neutralized by 50% or more to the acid values of the copolymers, and it is more preferred to be neutralized by 80% or more to the acid values of the copolymers. The water-soluble resins having weight average molecular weight of from 2,000 to 15,000 are preferred, and those having weight average molecular weight of from 3,500 to 100,000 are more preferred. These water-soluble resins may be used singly, or two or more kinds of water-soluble resins may be used in combination.

The impregnation liquid according to the invention can contain a water-soluble solvent besides at least one resin selected from the group consisting of the hardly water soluble resin and the water-soluble resin. The examples of the water-soluble solvents include polyvalent alcohols, e.g., glycerol, 1,2,6-hexanetriol, ethylene glycol, propylene glycol, diethylene glycol, triethylene glycol, tetraethylene glycol, dipropylene glycol, polyethylene glycol, 2-butene-1,4-diol, 2-ethyl-1,3-hexanediol, 2-methyl-2,4-pentanediol, 1,2-octanediol, 1,2-hexanediol, 1,6-hexanediol, 2,5-hexane-diol, 1,2 pentanediol, 1,5-pentanediol, 4-methyl-1,2-pentanediol, etc., alkyl alcohols having from 1 to 5 carbon atoms, e.g., methyl alcohol, ethyl alcohol, n-propyl alcohol, isopropyl alcohol, n-butyl alcohol, sec-butyl alcohol, tert-butyl alcohol, isobutyl alcohol, n-pentanol, etc., glycol ethers, e.g., ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-iso-propyl ether, diethylene glycol mono-iso-propyl ether, ethylene glycol mono-n-butyl ether, diethylene glycol mono-n-butyl ether, triethylene glycol mono-n-butyl ether, ethylene glycol mono-t-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-iso-propyl ether, dipropylene glycol monomethyl ether, dipropylene glycol monoethyl ether, dipropylene glycol mono-n-propyl ether, dipropylene glycol mono-iso-propyl ether, propylene glycol mono-n-butyl ether, dipropylene glycol mono-n-butyl ether, etc., amides, e.g., dimethylformamide, dimethylacetamide, etc., ketone or ketone alcohols, e.g., acetone, diacetone alcohol, etc., ethers, e.g., dioxane, etc., 2-pyrrolidone, N-methyl-2-pyrrolidone, sulforan, etc. These water-soluble solvents can be used singly, or in combination of two or more thereof. From the viewpoint of drying prevention of inks captured by a capturing member, it is preferred that at least one of these water-soluble solvents is a high boiling point and low evaporation solvent having vapor pressure at 20° C. of 0.01 mmHg or less, and more preferably having vapor pressure at 20° C. of 0.005 mmHg or less.

In addition to at least one resin selected from the group consisting of the hardly water soluble resin and the water soluble resin, and the water-soluble solvent, the impregnation liquid according to the invention can contain, for example, a solid humectant, a pH adjustor, a surfactant, an antiseptic and an antifungal agent.

As the solid humectants, those having a melting point of 20° C. or more and the solubility in water at 20° C. of 5 wt % or more are preferably used. Specifically, alcohols, e.g., 1,4-butanediol, 2,3-butanediol, 2-ethyl-2-(hydroxymethyl)-1,3-propanediol, etc., esters, e.g., ethylene carbonate, etc., nitrogen compounds, e.g., acetamide, N-methylacetamide, 2-pyrrolidone, ε-caprolactam, urea, thiourea, N-ethylurea, etc., and saccharides, e.g., dihydroxyacetone, erythritol, D-arabinose, L-arabinose, D-xylose, 2-deoxy-β-D-ribose, D-lyxose, L-lyxose, D-ribose, D-arabitol, ribitol, D-altrose, D-allose, D-galactose, L-galactose, D-quinovose, D-glucose, D-digitalose, D-digitoxose, D-cymarose, L-sorbose, D-tagatose, D-talose, 2-deoxy-D-glucose, D-fucose, L-fucose, D-fructose, D-mannose, L-rhamnose, D-inositol, myo-inositol, D-glucitol, D-mannitol, methyl=D-galactopyranoside, methyl=D-glucopyranoside, methyl=D-mannopyranoside, N-acetylchitobiose, isomaltose, xylobiose, gentiobiose, kojibiose, chondrosine, sucrose, cellobiose, sophorose, α,α-trehalose, maltose, melibiose, lactose, laminaribiose, rutinose, gentianose, stachyose, cellotriose, planteose, maltotriose, melezitose, lacto-N-tetraose, raffinose, etc., can be exemplified.

As the pH adjustors, hydroxides of alkali metals, e.g., lithium hydroxide, potassium hydroxide, sodium hydroxide, etc., and amines, e.g., ammonia, triethanolamine, tripropanolamine, diethanolamine, monoethanolamine, etc., can be used. Further, if necessary, collidine, imidazole, phosphoric acid, 3-(N-morpholino)propanesulfonic acid, tris(hydroxymethyl)aminomethane, boric acid, etc., can be used.

As the surfactants, anionic surfactants, cationic surfactants, amphoteric surfactants, and nonionic surfactants can be used. As the specific examples of the nonionic surfactants, acetylene glycol surfactants, acetylene alcohol surfactants, ethers, e.g., polyoxyethylene nonyl phenyl ether, polyoxyethylene octyl phenyl ether, polyoxyethylene dodecyl phenyl ether, polyoxyethylene alkyl allyl ether, polyoxy-ethylene oleyl ether, polyoxyethylene lauryl ether, polyoxyethylene alkyl ether, polyoxyalkylene alkyl ether, etc., esters, e.g., polyoxyethylene oleic acid, polyoxy-ethylene oleic ester, polyoxyethylene distearic ester, sorbitan laurate, sorbitan monostearate, sorbitan monooleate, sorbitan sesquioleate, polyoxyethylene monooleate, polyoxy-ethylene stearate, etc., silicone surfactants, e.g., dimethylpolysiloxane, etc., and fluorine-containing surfactants, e.g., fluorine alkyl ester, perfluoroalkyl-carboxylic acid salt, etc., can be exemplified. Of the above nonionic surfactants, acetylene glycol surfactants and acetylene alcohol surfactants are preferred for little in foaming and having an excellent defoaming property. As further specific examples of the acetylene glycol surfactants and acetylene alcohol surfactants, 2,4,7,9-tetramethyl-5-decyne-4,7-diol, 3,6-dimethyl-4-octyne-3,6-diol, 3,5-dimethyl-1-hexyne-3-ol, etc., can be exemplified. Commercial products are also available, e.g., Surfynol 104, 82, 465, 485, and TG, manufactured by Air Products and Chemicals, Inc., and OLFINE STG, OLFINE E1010, manufactured by Nisshin Chemical Industry Co., Ltd., etc., can be exemplified.

As the antiseptics and an antifungal agents, e.g., sodium benzoate, sodium pentachlorophenol, sodium 2-pyridinethiol-1-oxide, sodium sorbitanate, sodium dehydroacetate, and 1,2-benzisothiazolin-3-one (Proxel BZ, Proxel BD20, Proxel GXL, Proxel XL2, Proxel TN, manufactured by Arch Chemicals Inc.) can be exemplified.

The impregnation liquid in the invention is preferably water. The main solvent component is water. The impregnation liquid in the invention can be manufactured by merely mixing at least one resin selected from the group consisting of the hardly water-soluble resin and the water-soluble resin, and according to circumstances the water-soluble solvent, with water.

The content of the hardly water-soluble resin in the impregnation liquid in the invention is not especially restricted so long as the accumulation of pigment particles on the capturing member can be prevented or restrained by making the impregnation liquid be carried by the capturing member. The carrying amount of the hardly water-soluble resin on the capturing member can be adjusted according to the ink to be used.

The content of the water-soluble resin in the impregnation liquid in the invention is also not hardly restricted so long as the accumulation of pigment particles on the capturing member can be prevented or restrained by making the impregnation liquid be carried by the capturing member. The greatest lower bound of the carrying amount of the water-soluble resin on the capturing member is preferably 1 mg/g.

The impregnation liquid in the invention is used by impregnation into a capturing member. In the specification of the invention, “a capturing member” is a thing to be used as a member to directly capture ink droplets ejected to the areas other than a recording medium of the ink droplets ejected from a printer head for ink-jet recording, which has been conventionally used in a printer for ink-jet recording under the name of “an ink absorber” and the like for the same purpose. Further, “the areas other than a recording medium” are arbitrary areas ejected with ink droplets other than a recording medium, representatively the outside areas contiguous to the periphery of a recording medium in rimless printing, which also includes ejection area in cleaning treatment of printer heads. The cleaning treatment is treatment carried out for the purpose of avoiding ejection failure of a printer head by forcedly making the printer head pass and eject an ink composition in prescribed home position to which a recording medium is not transferred. The capturing member can also be provided at this home position.

Similarly to a conventionally used capturing member of the same kind, it is necessary for the capturing member in the invention to make ink droplets ejected from an ink head directly land and receive to completely capture the ink droplets. For example, in rimless printing, when ink droplets ejected to the outside area of a recording medium are not completely captured and floating on the periphery of the recording medium in the state like mist, the recorded image and recording medium are soiled, and further sometimes the surface of touching face of the platen with a recording medium is soiled. Even when the printer is turned by 90° or so in changing installation place of the printer and the like in the state of ink liquid being captured by the capturing member, it is preferred for the capturing member to have holding performance so as not to leak out the ink liquid. Further, it is necessary for the capturing member to maintain competence to transfer captured ink liquid in order to the waste ink tank and capture the next ink droplets.

The capturing member for use in the invention can be prepared from optional materials having the above functions. Porous materials conventionally used as capturing members are preferably used, and a continuous porous material comprising pores communicating with each other are especially preferred. As the porous materials, e.g., foam sheets or porous sheets of plastics, and sheets of fibrous materials (e.g., webs, network materials, fabrics, knitted materials, non-woven fabrics) can be used. As foam sheets of plastics, e.g., polyurethane foam, polyvinyl alcohol (PVA) sponge, fluorine resin porous product can be exemplified.

The capturing member for use in the invention may be a single layer structure or a multilayer structure comprising two or more layers. When the capturing member comprises two layers, it is preferred that two layers comprise an ink receptive layer and an ink diffusive layer. The ink receptive layer is a layer to make the ink droplets ejected from a printer head directly land and capture, and the ink diffusive layer is a layer to transfer the ink liquid captured by the ink receptive layer to a waste ink tank while holding the ink liquid. It is more preferred that the ink receptive layer and the ink diffusive layer are at least partly brought into contact with each other, and a material having higher absorption than the material in the ink receptive layer is used in the ink diffusive layer. Further, each of the ink receptive layer and the ink diffusive layer may comprise a multilayer structure of two or more layers.

As the combination of the ink receptive layer and the ink diffusive layer, for example, a combination of a network sheet made of a polymer compound having water repellency (e.g., made of plastics) with a porous sheet of a hydrophilic polymer compound and a felt material, and a combination of a polyurethane foam sheet with a PVA sponge sheet can be exemplified.

A method of impregnating the capturing member for use in the invention with at least one resin selected from the group consisting of a hardly water soluble resin and a water-soluble resin, and allowing it to carry the resin is not especially restricted. For example, methods of soaking, spraying and coating can be used. The capturing member for use in the invention can contain the thus-impregnated at least one resin selected from the group consisting of a hardly water-soluble resin and a water-soluble resin in a wet state or in a dry state, and contain the resin in a wet state is preferred.

The amount of the at least one resin selected from the group consisting of a hardly water soluble resin and a water-soluble resin carried by the capturing member for use in the invention is not especially restricted so long as the amount is capable of effectively preventing accumulation of pigment particles on the surface of the capturing member, and the amount can be appropriately determined according to the ink composition and the kind of the capturing member used. For example, in the case of a capturing member comprising polyurethane foam, it is preferred to contain the at least one resin selected from the group consisting of a hardly water soluble resin and a water-soluble resin in an amount of 5 mg/g or more, more preferably 20 mg/g or more, and still more preferably 50 mg/g or more.

An ink-jet printer for use in the invention is not especially restricted so long as the capturing member can be mounted and ordinary printers can be utilized as they are. The kind of ink-jet recording system is not also restricted, and apparatus of ejecting ink droplets by vibrating piezo vibrator by recording signals, and apparatus of applying heat energy corresponding to recording signals to the recording liquid in a recording head room, and generating ink droplets by the heat energy can be used.

### EXAMPLES

The invention will be illustrated in detail with reference to the following Examples, but the scope of the invention should not be construed as being restricted thereto. Incidentally, in the following Examples, “parts” and “%” are given by weight unless otherwise indicated.

### Example 1-1

### (1) Preparation of Reaction Product A

A flask having a capacity of 12 liters equipped with a mechanical stirrer, a thermometer, N2 inlet, an outlet of drying pipe and an addition funnel was charged with 4,002 g of tetrahydrofuran (THF) and 7.7 g of p-xylene. Thereafter, 2.0 ml of a 1.0M acetonitrile solution of tetrabutylammonium p-chlorobenzoate was added thereto as a catalyst. As an initiator, 155.1 g (0.891M) of 1-methoxy-1-trimethylsiloxy-2-methylpropene was injected. A feed of 2,801 g (17.8M) of 2-dimethylaminoethyl methacrylate was initiated, and the feed was carried out over 45 minutes. After the elapse of 100 minutes from the completion of the feed (the monomer exceeding 99% was reacted), a feed of 2,045 g (14.4M) of butyl methacrylate was initiated, and the feed was performed over 30 minutes. At a point of time after the elapse of 400 minutes, 310 g of dry methanol was added to the solution and distillation was initiated. The solvent of 1,725 g (in total) was eliminated. After completion of distillation, 1,783 g of isopropanol was added thereto. A diblock polymer of butyl methacrylate/dimethylaminoethyl methacrylate (20/20) (solid content: 49.6%) was manufactured in this manner. Subsequently, the polymer was neutralized with 2,052 g (17.8M) of concentrated phosphoric acid and converted to water, thus a 15% solution of reaction product A of the polymer salt was manufactured.

### (2) Preparation of Emulsion

Water (233 g), 25 g of n-butyl methacrylate and 25 g of the reaction product A were refluxed in a reaction vessel. At a point of time of reflux, 27.5 g of water and 0.68 g of VA-044 (manufactured by Wako Pure Chemical Industries) were added thereto. In a different flask, 561 g of water, 225 g of n-butyl methacrylate, and 142 g of reaction product A were thoroughly mixed with an Eppenbach homogenizer. In the next place, the above mixed product was put in the reaction flask over 100 minutes. After completion of addition of the mixed product, the content of the reaction flask was further refluxed for 60 minutes, and then a mixture of 12.5 g of water and 0.68 g of VA-044 was added to the reaction flask. The content of the reaction flask was further refluxed for 60 minutes, and then cooled to room temperature to obtain an emulsion. The solid content of the obtained emulsion was 23%. Thus, emulsion A was obtained.

Impregnation liquid 1-A was prepared by blending emulsion A in proportion of 30%, glycerol 54%, triethylene glycol monobutyl ether 10%, 1,2-hexanediol 5%, 1,2-benz-isothiazolin-3-on (Proxel XL2, manufactured by Arch Chemicals Inc.) 0.1%, and triethanolamine 0.9%.

### Example 1-2

### (1) Preparation of Reaction Product B

A flask having a capacity of 12 liters equipped with a stirrer, a thermometer, N2 inlet, an outlet of drying pipe and an addition funnel was charged with 3,027 g of tetrahydrofuran (THF) and 6.2 g of p-xylene. Thereafter, 2.5 ml of a 11.0M acetonitrile solution of tetrabutylammonium p-chlorobenzoate was added thereto as a catalyst. As an initiator, 234.4 g of 1,1-bis(trimethylsiloxy)-2-methylpropene was injected. A feed of 2.5 ml of a 1.0M acetonitrile solution of tetrabutylammonium p-chlorobenzoate was initiated, and all the amount was added over 150 minutes. Subsequently, a feed of 1,580 g of trimethylsilyl methacrylate was initiated, and the entire amount was added over 30 minutes. After the elapse of 120 minutes from the completion of the feed, feedings of 1,425 g of butyl methacrylate and 503 g of methyl methacrylate were initiated, and the entire amount was added over 30 minutes. At a point of time after the elapse of 320 minutes, 650 g of dry methanol was added to the solution and distillation was initiated. During the time of the first stage of distillation, 1,250.0 g of the substance was eliminated from the flask. Isopropanol (1,182 g) was added to the reaction product. Distillation was continued and the solvent in total of 2,792 g was removed.

By the above operation, butyl methacrylate/methyl methacrylate/methacrylic acid AB block polymer (10/5/10) having number average molecular weight (Mn) of 2,900, and solid content of 50.5% was manufactured. An aqueous solution of reaction product B was prepared by blending 396 g of the obtained polymer, 68 g of 2-amino-2-methyl-1-propanol (AMP), and 1,536 g of deionized water.

### (2) Preparation of Emulsion

An emulsion was prepared by adding 637 g of methyl methacrylate and 63 g of n-butyl methacrylate to 700 g of reaction product B prepared in the above item (1) and 315 g of deionized water in a high speed stirrer (homogenizer). Stirring was continued for about 30 minutes until a mixed product having a solid content of 45 wt % emulsified in advance was formed. Polymerization was performed on a laboratory scale with an oven made of resin equipped with a dropping funnel containing the emulsified mixed product, an air stirrer, a nitrogen inlet, and a mantel for heating. Deionized water of an amount to make the solid content of final product 25% was put in the oven. The air in the oven was replaced with nitrogen and water was heated to 70 to 72° C. In the next place, one tenth of the mixture emulsified in advance, a 2% aqueous solution of sodium bisulfite, and a 6.5 wt % of an aqueous solution of 0.25% of ammonium persulfate (on the basis of the weight of the monomer used for the emulsified mixture) were added to the oven made of resin. The temperature was raised to 80° C. and the temperature was maintained during the time of polymerization. The remaining emulsified mixture and the aqueous solution of sodium bisulfite were added to the oven over 75 minutes. The total amount of sulfurous acid products added was 0.14% based on the concentration of the monomer. An aqueous ammonium persulfate solution of the two time amount was prepared, and added separately in three parts. The first addition was performed at the intermediate point of the additions of the emulsified mixture and sodium bisulfite, the second time was carried out at the time when additions of these substances were finished, and the third addition was 15 minutes after the second addition. The obtained latex was maintained at 80 to 85° C. for 120 minutes, and then cooled and filtered. Thus, emulsion B was obtained.

Impregnation liquid 1-B was prepared by blending emulsion B in proportion of 15%, glycerol 50%, polyethylene glycol #400 30%, 1,2-hexanediol 4%, 1,2-benzisothiazolin-3-on (Proxel XL2, manufactured by Arch Chemicals Inc.) 0.3%, and triethanolamine 0.7%.

### Example 1-3

Impregnation liquid 1-C was prepared by blending styrene-acryl copolymer resin (JONCRYL 631, manufactured by Johnson Polymer Corporation) as the hardly water-soluble resins in proportion of 10%, tripropanolamine 1%, and water 89%.

### Example 1-4

Impregnation liquid 1-D was prepared by blending styrene-acryl copolymer resin (JONCRYL 790, manufactured by Johnson Polymer Corporation) as the hardly water-soluble resins in proportion of 10%, potassium hydroxide 0.1%, 1,2-benzisothiazolin-3-on (Proxel XL2, manufactured by Arch Chemicals Inc.) 0.1%, and water 89.8%.

### Example 2-1

A four-neck flask equipped with a stirrer, a cooling pipe, and nitrogen gas-introducing pipe was charged with 350 parts of butyl acetate and heated to 105° C. While introducing nitrogen gas, a mixture comprising 31 parts of methacrylic acid, 129 parts of methyl methacrylate, 40 parts of stearyl methacrylate, and 5 parts of benzoyl peroxide as the initiator was dropped into the flask over 2 hours, and the reaction mixture was allowed to be copolymerized for 2 hours while maintaining the same temperature. Butyl acetate was removed to thereby obtain an acrylic copolymer resin having weight average molecular weight of 11,000 and acid value of 100 mg KOH/g. Impregnation liquid 2-A was prepared as aqueous solution A of an aqueous resin having a solid content of resin of 10% by heat dissolving 10 parts of the acrylic copolymer resin in 90 parts of a sodium hydroxide aqueous solution obtained by dissolving sodium hydroxide corresponding to 100% of neutralization amount of the copolymer.

### Example 2-2

A four-neck flask equipped with a stirrer, a cooling pipe, and nitrogen gas-introducing pipe was charged with 350 parts of butyl acetate and heated to 105° C. While introducing nitrogen gas, a mixture comprising 20 parts of acid phosphonyl methacrylate, 120 parts of methyl methacrylate, 60 parts of butyl acrylate, and 5 parts of benzoyl peroxide as the initiator was dropped into the flask over 2 hours, and the reaction mixture was allowed to be copolymerized for 2 hours while maintaining the same temperature. Butyl acetate was removed to thereby obtain an acrylic copolymer resin having weight average molecular weight of 12,000 and acid value of 165 mg KOH/g. Impregnation liquid 1-B was prepared as aqueous solution B of an aqueous resin having a solid content of resin of 10% by heat dissolving 10 parts of the acrylic copolymer resin in 90 parts of a triethanolamine aqueous solution obtained by dissolving triethanolamine corresponding to 100% of neutralization amount of the copolymer.

### Example 2-3

A four-neck flask equipped with a stirrer, a cooling pipe, and nitrogen gas-introducing pipe was charged with 350 parts of butyl acetate and heated to 105° C. While introducing nitrogen gas, a mixture comprising 95 parts of methacrylic acid, 65 parts of methyl methacrylate, 40 parts of stearyl methacrylate, and 5 parts of benzoyl peroxide as the initiator was dropped into the flask over 2 hours, and the reaction mixture was allowed to be copolymerized for 2 hours while maintaining the same temperature. Butyl acetate was removed to thereby obtain an acrylic copolymer resin having weight average molecular weight of 11,000 and acid value of 310 mg KOH/g. Impregnation liquid 2-C was prepared as aqueous solution C of an aqueous resin having a solid content of resin of 10% by heat dissolving 10 parts of the acrylic copolymer resin in 90 parts of a potassium hydroxide aqueous solution obtained by dissolving potassium hydroxide corresponding to 100% of neutralization amount of the copolymer.

### Example 2-4

Aqueous solution D of an aqueous resin was prepared by blending an aqueous solution of acryl copolymer resin containing an acryl copolymer resin (JONCRYL 62, manufactured by Johnson Polymer Corporation) as the water-soluble resins in proportion of 10%, glycerol 70%, tripropanolamine 1%, 1,2-benzisothiazolin-3-on (Proxel XL2, manufactured by Arch Chemicals Inc.) 0.1%, and water 18.9%, and this solution was designated impregnation liquid 2-D.

### Example 2-5

Aqueous solution E of an aqueous resin was prepared by blending aqueous solution A of an aqueous resin prepared in Example 2-1 in proportion of 10%, glycerol 60%, triethylene glycol mono-n-butyl ether 5%, 2-ethyl-2-(hydroxymethyl)-1,3-propanediol 5%, and water 20%, and this solution was designated impregnation liquid 2-E.

### Example 2-6

Aqueous solution F of an aqueous resin was prepared by blending aqueous solution B of an aqueous resin prepared in Example 2-2 in proportion of 5%, an aqueous solution of acryl copolymer resin (JONCRYL 62, manufactured by Johnson Polymer Corporation) 5%, 1,2,6-hexanetriol 80%, and water 10%, and this solution was designated impregnation liquid 2-F.

### Example 2-7

Aqueous solution G of an aqueous resin was prepared by blending aqueous solution C of an aqueous resin prepared in Example 2-3 in proportion of 30%, glycerol 44%, triethylene glycol 20%, 1,2-hexanediol 5%, 1,2-benzisothiazolin-3-on (Proxel XL2, manufactured by Arch Chemicals Inc.) 0.1%, and triethanolamine 0.9%, and this solution was designated impregnation liquid 2-G.

### (Evaluation of Physical Properties)

### (1) Preparation of the Material of Capturing Member (Foam))

As the capturing member to be impregnated with impregnation liquids prepared in Examples 1-1 to 1-4, 2-1 to 2-7, soft polyurethane foam was prepared. Specifically, soft polyurethane foam was obtained by one shot method from 100 parts of polyol (V3030, manufactured by The Dow Chemical Company), 50 parts of tolylene diisocyanate (TDI80, manufactured by NIPPON POLYURETHANE INDUSTRY CO., LTD.), 4 parts of water, 0.3 parts of amine catalyst (DABCO-33LV, manufactured by Mitsui Air Products), 0.3 parts of tin catalyst (stannous octoate, manufactured by Nitto Kasei Co., Ltd.), and 1 part of silicone foam adjustor (L-520, manufactured by Nippon Unicar Co., Ltd.). The polyurethane foam was compressed under heating to compression degree of ×5. The obtained foam was continuous porous material having the degree of aeration of 2.0 cm³/cm²/sec.

### (2) Impregnation Treatment

Subsequently, the obtained foam for the capturing member (100 cm×100 cm×0.5 cm) was uniformly impregnated with each of impregnation liquids 1-A to 1-D, 2-A to 2-G prepared in Examples 1-1 to 1-4, 2-1 to 2-7 in an amount of 5 g/g per weight, and capturing members for experiment were prepared. For comparison, foam for a capturing member not impregnated with an impregnation liquid was prepared (Comparative Example 1).

### (3) Printing Test

Impregnated capturing member obtained in the above item (2) was mounted on the platen part of ink-jet printer (PX-V500, manufactured by Seiko Epson Corporation). Under the condition of 40° C. RH 20%, rimless printing was continuously performed on post card paper for ink-jet printing, and the number of times of printing (the number of sheets) required until back soiling was generated was investigated. The generation of back soiling was visually judged of the post card paper after printing. The results obtained are shown in Table 1 below.

TABLE 1

| Kind of | Number of Times |
|---|---|
| Impregnation Liquid | of Printing |
| 1-A (Example 1-1) | 1,200 |
| 1-B (Example 1-2) | 1,300 |
| 1-C (Example 1-3) | 700 |
| 1-D (Example 1-4) | 600 |
| 2-A (Example 2-1) | 1,000 |
| 2-B (Example 2-2) | 900 |
| 2-C (Example 2-3) | 1,100 |
| 2-D (Example 2-4) | 1,300 |
| 2-E (Example 2-5) | 1,250 |
| 2-F (Example 2-6) | 1,400 |
| 2-G (Example 2-7) | 1,450 |
| None (Comparative Example 1) | 200 |

While the invention has been described in detail and with reference to specific embodiments thereof, it will be apparent to one skilled in the art that various changes and modifications can be made therein without departing from the spirit and scope thereof.

The present application is based on Japanese Patent Application No. 2005-063481 filed on Mar. 8, 2005 and Japanese Patent Application No. 2005-063488 filed on Mar. 8, 2005, and the contents thereof are herein incorporated by reference.

### INDUSTRIAL APPLICABILITY

The impregnation liquid in the invention containing at least one resin selected from the group consisting of a hardly water-soluble resin and a water-soluble resin can be used to be impregnated into a capturing member for directly capturing ink droplets ejected to the areas other than a recording medium, among the ink droplets in rimless printing by an ink-jet recording method, and accumulation of pigment particles on the surface of the capturing member can be effectively prevented or restrained.

The capturing member of the invention impregnated with the impregnation liquid to carry the at least one resin selected from the group consisting of a hardly water-soluble resin and a water-soluble resin can be used as the capturing member for directly capturing ink droplets ejected to the areas other than a recording medium, among the ink droplets in rimless printing by an ink-jet recording method, and accumulation of pigment particles on the surface of the capturing member can be effectively prevented or restrained.

The ink-jet printer of the invention is equipped with the capturing member and accumulation of pigment particles on the surface of the capturing member can be effectively prevented or restrained.

1. An impregnation liquid that is to be impregnated in a capturing member for directly capturing ink droplets ejected to an area other than a recording medium among ink droplets ejected from a printer head for ink-jet recording, which contains at least one resin selected from the group consisting of a hardly water-soluble resin and a water-soluble resin.

2. The impregnation liquid as claimed in claim 1, wherein the hardly water-soluble resin contains a hardly water-soluble resin obtained by polymerization of at least one monomer selected from the group consisting of acrylic monomer, methacrylic monomer, vinyl monomer, maleic acid, maleic anhydride, styrene, itaconic acid, N-vinylpyrrolidone, acrylamide, methacrylamide, and derivatives thereof.

3. The impregnation liquid as claimed in claim 2, wherein the methacrylic monomer comprises at least one monomer selected from the group consisting of methyl methacrylate (MMA), ethyl methacrylate (EMA), propyl methacrylate, n-butyl methacrylate (MBA or NBMA), hexyl methacrylate, 2-ethylhexyl methacrylate (EHMA), octyl methacrylate, lauryl methacrylate (LMA), stearyl methacrylate, phenyl methacrylate, hydroxyethyl methacrylate (HEMA), hydroxypropyl methacrylate, ethoxytriethylene glycol methacrylate (ETEGMA), 2-ethoxyethyl methacrylate, methacrylonitrile, 2-trimethylsiloxyethyl methacrylate, glycidyl methacrylate (GMA), p-tolyl methacrylate, methacrylic acid (MAA), dimethylaminoethyl methacrylate (DMAEMA), diethylaminoethyl methacrylate, t-butylaminoethyl methacrylate, and sorbyl methacrylate.

4. The impregnation liquid as claimed in claim 2, wherein the acrylic monomer comprises at least one monomer selected from the group consisting of methyl acrylate, ethyl acrylate, propyl acrylate, butyl acrylate, hexyl acrylate, 2-ethylhexyl acrylate, octyl acrylate, lauryl acrylate, stearyl acrylate, phenyl acrylate, hydroxyethyl acrylate, hydroxypropyl acrylate, acrylonitrile, 2-trimethylsiloxy-ethyl acrylate, glycidyl acrylate, p-tolyl acrylate, sorbyl acrylate, acrylic acid, dimethylaminoethyl acrylate, and diethylaminoethyl acrylate.

5. The impregnation liquid as claimed in claim 1, wherein the water-soluble resin is a compound having a hydrophilic structural part and a hydrophobic structural part.

6. The impregnation liquid as claimed in claim 1, which further contains a water-soluble solvent.

7. The impregnation liquid as claimed in claim 6, wherein the water-soluble solvent comprises at least one member having a vapor pressure at 20° C. of 0.01 mmHg or less.

8. A capturing member for an ink-jet printer for directly capturing ink droplets ejected to an area other than a recording medium among ink droplets ejected from a printer head for ink-jet recording, which is impregnated with and contains at least one resin selected from the group consisting of a hardly water-soluble resin and a water-soluble resin.

9. The capturing member as claimed in claim 8, which carries the at least one resin selected from the group consisting of a hardly water-soluble resin and a water-soluble resin in a wet state or in a dry state.

10. The capturing member as claimed in claim 8, which has a multilayer structure.

11. An ink-jet printer equipped with the capturing member as claimed in claim 8.

12. The ink-jet printer as claimed in claim 11, wherein a colorant of ink to be used is a pigment.
